(19) United States
(12) Patent Application Publication
(10) Pub. No.: US 2019/0093260 A1
(43) Pub. Date: Mar. 28, 2019

(54) ELECTRICALLY CONDUCTIVE YARN

(71) Applicant: CHAKYU DYEING CO., LTD., Ichinomiya-shi (JP)

(72) Inventor: Masaaki HACHIYA, Aichi (JP)

(21) Appl. No.: 16/085,677

(22) PCT Filed: Nov. 30, 2016
(86) PCT No.: PCT/JP2016/085572

§ 371 Date: Sep. 17, 2018

(30) Foreign Application Priority Data
Apr. 22, 2016 (JP) 2016-085658

(51) Int. Cl. D02G 3/44; D02G 3/36; D06M 11/74; D06M 11/83; D06M 11/45; H01B 5/02; H01B 1/24; H01B 1/22; H01B 3/30

(52) U.S. Cl. CPC D02G 3/441; D02G 3/36; D06M 11/74; D06M 11/83; D06M 2101/38; H01B 5/02; H01B 1/24; H01B 1/22; H01B 3/302; D06M 11/45

(57) ABSTRACT

An electrically conductive yarn (1) includes a plurality of individual filaments (2) and an electrically conductive portion (3) that covers surface of the individual filaments (2). The electrically conductive portion (3) contains a carbon-based material, in particular carbon nanotubes, a binder, and a metal. The electrically conductive portion (3) has a network structure in which the carbon nanotubes are connected to one another and is constituted such that the metal is interspersed within the network structure. The electrically conductive portion (3) may further contain Al₂O₃.

### TECHNICAL FIELD

The present invention relates to an electrically conductive yarn.

### BACKGROUND ART

An electrically conductive yarn, which includes electrically conductive fibers constituted by synthetic yarns and an electrically conductive layer that coats the surface of the synthetic yarns and includes carbon nanotubes, a binder, and a surfactant, is known in the art (Patent Document 1).

### PRIOR ART LITERATURE

### Patent Documents

Patent Document 1

Japanese Patent No. 5557992

### SUMMARY OF THE INVENTION

### Problems to be Solved by the Invention

However, even though the electrically conductive yarn of Patent Document 1 has low electrical resistance, it is 280 Ω/cm. Consequently, even though the known electrically conductive yarn is lightweight and has flexing resistance, it has a high electrical resistance and therefore is difficult to use as a substitute for metal wire such as copper wire. That is, because the electrical resistance of the known electrically conductive yarn is high, its application has been limited.

The present invention was conceived considering the above-described background and it is an object of the present invention to provide an electrically conductive yarn in which electrical resistance can be reduced compared with the past.

### Means for Solving the Problems

One aspect of the present invention is an electrically conductive yarn comprising: a plurality of individual filaments; and an electrically conductive portion that covers a surface of each of the individual filaments; wherein the electrically conductive portion contains a carbon-based material—which includes carbon nanotubes—a binder, and a metal, and has a network structure in which the carbon nanotubes are connected to one another; and the metal is interspersed within the network structure.

### Effects of the Invention

In the above-described electrically conductive yarn, the electrically conductive portion contains the carbon-based material, the binder, and the metal. Consequently, the electrical conductivity of the electrically conductive portion is greatly increased due to the synergistic effect between the carbon-based material and the metal. For that reason, the electrically conductive yarn can greatly reduce electrical resistance compared with the past. In particular, in the above-described electrically conductive yarn, the carbon-based material contains carbon nanotubes, the electrically conductive portion has a network structure in which the carbon nanotubes are connected to one another, and the metal is interspersed within the network structure. Consequently, the above-described electrically conductive yarn makes possible, with certainly, a reduction of the electrical resistance of the electrically conductive portion. Although details are unknown, it is conjectured that, because the metal, which has high electrical conductivity, is present in the network structure of the carbon nanotubes in an interspersed manner, a voltage drop is less likely to occur. Accordingly, it becomes possible to apply the electrically conductive yarn to various applications in which reduced weight, flexing resistance, and low electrical resistance are required.

### BRIEF DESCRIPTION OF THE DRAWINGS

FIG. 1 is a drawing that schematically shows a cross section of the electrically conductive yarn of working example 1.

FIG. 2 is a scanning electron microscope (SEM) image that shows a surface of the electrically conductive yarn of sample 1 according to working example 1.

FIG. 3 is an SEM image that shows an enlargement of the surface of the electrically conductive yarn of sample 1 according to working example 1.

FIG. 4 is the result of SEM-X-ray fluorescence analysis (EDX) in the same visual field as FIG. 3.

### MODES FOR CARRYING OUT THE INVENTION

In the above-described electrically conductive yarn, the individual filaments can be composed of, for example, synthetic fibers, natural fibers, or the like. From the viewpoint of lightweightness, flexing resistance, strength, etc., the individual filaments preferably can be composed of synthetic fibers. For example, polyester-based resins, polyamide-based resins, polyolefin-based resins, acrylic-based resins, polyurethane-based resins, and the like can be given as examples of resins used as the synthetic fibers. It is noted that, in the electrically conductive yarn, the individual filaments can be composed of one or two or more resins.

In the electrically conductive yarn, an electrically conductive portion covers not only the individual filaments located at the surface of the electrically conductive yarn but also the surfaces of the individual filaments located in the interior of the electrically conductive yarn. Accordingly, the electrically conductive portion integrally joins adjacent individual filaments to one another.

Here, the electrically conductive portion contains a carbon-based material, a binder, and a metal.

For example, carbon nanotubes, graphene, and the like can be given as examples of the carbon-based material. From the viewpoint of electrical conductivity, formability of a network structure, and the like, the carbon-based material contains at least carbon nanotubes. Preferably, carbon nanotubes, or carbon nanotubes and graphene, can be used as the carbon-based material. It is noted that the carbon nanotubes may have a structure that is either a single-wall type or a multi-wall type.

The binder functions to prevent the carbon-based material and the metal from coming off and to improve adhesion between the carbon-based material and the metal and between the carbon-based material and the individual filaments.

Specifically, for example, polyester-based resins, polyamide-based resins, polyolefin-based resins, acrylic-based resins, epoxy-based resins, polyurethane-based resins, and the like can be given as examples of the binder. One or two or more of these can be used in combination.

The metal (including alloys; hereinbelow, omitted), when used in combination with the carbon-based material, plays a role in facilitating an electrical resistance reduction of the electrically conductive portion. Specifically, the metal can have a granular form.

Specifically, for example, Ag, Sn, Cu, Al, Zn, Fe, Ni, Co, Mg, Ti, Au, Pt group, alloys thereof, and the like can be given as examples of the metal. One or two or more of these can be used in combination. The above-mentioned metals make possible, with certainty, a low electrical resistance of the electrically conductive portion. Among the above-mentioned metals, the metal is preferably Ag, Sn, Cu, Al, Zn, alloys thereof, or the like. Among the above-mentioned metals, more preferably, it should contain at least one of Ag and an Ag alloy from the viewpoint of being able to make possible, with greater certainty, a low electrical resistance of the electrically conductive portion, and even more preferably should be at least one of Ag and an Ag alloy. It is noted that the metal may be exposed at the surface of the electrically conductive portion but does not have to be exposed at the surface of the electrically conductive portion. If the metal is covered by the binder, then corrosion resistance of the electrically conductive yarn can be improved.

The electrically conductive portion can contain Al₂O₃. In this case, it is possible to achieve a reduction in the electrical resistance of the electrically conductive portion while also reducing the metal content. Consequently, in this case, the use of rare metals, such as Ag and Ag alloys, can be reduced, which is advantageous for lowering the cost of the electrically conductive yarn. The Al₂O₃ can have the above-described metal layer, such as Ag, on its surface.

Specifically, the electrically conductive portion can be constituted such that it contains 30-100 parts by mass of the metal with respect to 100 parts by mass of the electrically conductive portion. In this case, the electrical resistance of the electrically conductive portion can be reduced with certainty. From the viewpoint of facilitating a low electrical resistance of the electrically conductive portion, the metal content can contain, with respect to 100 parts by mass of the electrically conductive portion, preferably 35 parts by mass or more, more preferably 37 parts by mass or more, and even more preferably 40 parts by mass or more. From the viewpoint of reducing the weight of the electrically conductive yarn, the metal content can contain preferably 95 parts by mass or less, more preferably 90 parts by mass or less, and even more preferably 85 parts by mass or less. It is noted that the metal content contained in the electrically conductive portion can be measured by performing acidolysis on a sample of the electrically conductive yarn using a microwave pyrolysis apparatus and then measuring the obtained solution using an ICP emission spectrophotometer (a high-frequency inductively coupled plasma emission spectrophotometer).

The electrical resistance of the electrically conductive yarn should be 30 Ω/cm or less. In this case, it becomes easier to substitute for metal wire, to use in combination with metal wire, or the like, thereby increasing applicability for various uses.

From the viewpoint of improving electrical conductivity, the electrical resistance can be preferably 25 Ω/cm or less, more preferably 20 Ω/cm or less, even more preferably 15 Ω/cm or less, and yet more preferably 10 Ω/cm or less. It is noted that, from the viewpoint of electrical conductivity, the lower the electrical resistance, the better; consequently, the lower limit of the electrical resistance is not particularly restricted.

The electrical resistance is the average value of the measured resistance values obtained by applying a voltage of 1,000 V to each of ten samples of the electrically conductive yarn, each having a length of 10 cm, in a constant-temperature and constant-humidity environment at 20° C. and 30% RH.

The electrically conductive yarn can be used in, for example, a conductor of an electric wire. The conductor can also comprise one of the above-mentioned electrically conductive yarns or may be constituted by a plurality of the electrically conductive yarns being twisted together. Specifically, the electric wire can comprise a conductor, having the above-mentioned electrically conductive yarn, and an insulative body, which covers an outer circumference of the conductor. An electric wire including the above-mentioned electrically conductive yarn is lightweight and has flexing resistance and can also reduce electrical resistance. Consequently, the electric wire can be ideally used in various applications, for example, a signal line of a robot arm, an earphone wire, a signal line of a wearable device, or the like.

It is noted that the various configurations discussed above can be arbitrarily combined, as needed, to obtain the various functions and effects discussed above.

### WORKING EXAMPLES

Electrically conductive yarns of the working examples will be explained below, using the drawings.

### Working Example 1

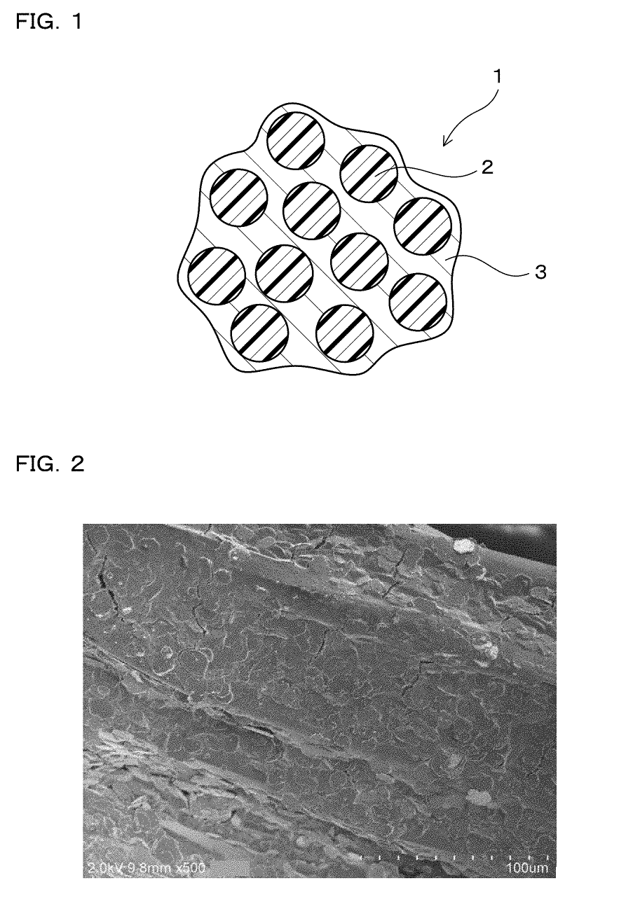

The electrically conductive yarn of working example 1 will now be explained, using FIG. 1. As shown in FIG. 1, an electrically conductive yarn 1 of the present example comprises a plurality of individual filaments 2 and an electrically conductive portion 3, which covers the surface of each individual filament 2. The electrically conductive portion 3 contains a carbon-based material, a binder, and a metal.

In the present example, the carbon-based material contains carbon nanotubes. The electrically conductive portion 3 has a network structure in which the carbon nanotubes are connected to one another. Furthermore, the metal is interspersed within the network structure. The metal is at least one of Ag and an Ag alloy. It is noted that each of the individual filaments 2 is composed of a synthetic resin. In addition, the binder is composed of a synthetic resin.

### EXPERIMENTAL EXAMPLES

The above-described electrically conductive yarn is specifically explained below using experimental examples.

### —Material Preparation—

A polyurethane-based multifilament (150d-48f-1) was prepared as the yarn. It is noted that the multifilament comprises a plurality of individual filaments.

Metal-containing CNT aqueous dispersion <1> (made by Parker Corporation) containing 5% by mass of multi-wall-type carbon nanotubes (CNT), 20.2 mass % of silver, 19.2% by mass of Al₂O₃, a dispersant, a surfactant, and water, was prepared.

Metal-containing CNT aqueous dispersion <2> (made by Parker Corporation) containing 5% by mass of multi-wall-type carbon nanotubes (CNT), 21.8 mass % of silver, 19.2% by mass of Al₂O₃, a dispersant, a surfactant, and water, was prepared. It is noted that, in the metal-containing CNT aqueous dispersions <1> and <2>, silver and a water-soluble compound of silver may be used in combination.

CNT aqueous dispersion <1C> (made by Parker Corporation) containing 5% by mass of multi-wall-type carbon nanotubes (CNT), a dispersant, a surfactant, and water, was prepared.

A polyurethane-based resin (“Evafanol HA1107C” made by Nicca Chemical Co.) was prepared as the binder.

Next, yarn-treatment liquid <1> was prepared by mixing 100 parts by mass of the metal-containing CNT aqueous dispersion <1> and 10 parts by mass of the binder. Likewise, yarn-treatment liquid <2> was prepared by mixing 100 parts by mass of the metal-containing CNT aqueous dispersion <2> and 10 parts by mass of the binder. In addition, yarn-treatment liquid <1C> was prepared by mixing 100 parts by mass of the CNT aqueous dispersion <1C> and 10 parts by mass of the binder.

### —Manufacture of Electrically Conductive Yarns—

A yarn-treatment apparatus comprising a large-diameter roller, wherein a lower part of the roller is immersed in a prescribed yarn-treatment liquid, and a small-diameter roller, which rotates by the rotation of the large-diameter roller, was prepared. Furthermore, while rotating the large-diameter roller and microvibrating the small-diameter roller using a vibrator, the yarn was passed between the large-diameter roller and the small-diameter roller, and the yarn-treatment liquid was dried at 170° C. for 2 min.

In the above-described yarn treatment, the electrically conductive yarn of sample 1 was obtained by using the yarn-treatment liquid <1>. In addition, the electrically conductive yarn of sample 2 was obtained by using the yarn-treatment liquid <2>. In addition, the electrically conductive yarn of sample 1C was obtained by using the yarn-treatment liquid <1C>. It is noted that, in each of the electrically conductive yarns of sample 1, sample 2, and sample 1C, the individual filaments located at the surface of the multifilament as well as the surfaces of the individual filaments located in the interior of the multifilament were covered by the electrically conductive portion formed by the respective yarn-treatment liquid.

### —SEM-X-Ray Fluorescence Analysis (EDX)—

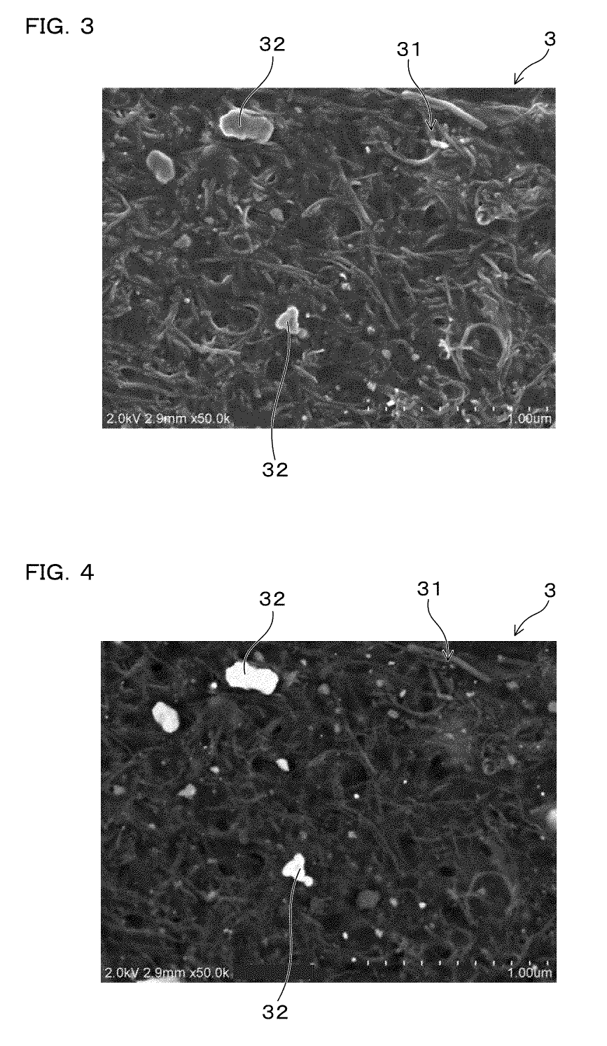

The surface of each electrically conductive yarn was observed using a scanning electron microscope (SEM). In addition, SEM-X-ray fluorescence analysis (EDX) was also performed. FIG. 2 to FIG. 4 show observation results of the electrically conductive yarn of sample 1. As shown in FIG. 2 to FIG. 4, in the electrically conductive yarn of sample 1, the electrically conductive portion 3 has a network structure 31, in which the carbon nanotubes are connected to one another, and it was confirmed that the electrically conductive portion 3 has a microstructure in which the metal 32 is interspersed within the network structure 31. It is noted that the results obtained for the electrically conductive yarn of sample 2 were the same as those obtained for the electrically conductive yarn of sample 1.

On the other hand, although not shown, in the electrically conductive yarn of sample 1C, because the yarn-treatment liquid did not contain metal, the electrically conductive portion did not have a microstructure in which metal is interspersed within the network structure in which the carbon nanotubes were connected to one another.

### —ICP Emission Spectroscopy—

The Ag content and the Al₂O₃ content in the electrically conductive portion were measured by performing acidolysis on the electrically conductive yarn samples using the microwave pyrolysis apparatus, diluting the obtained solutions as appropriate, and measuring the contents using the ICP emission spectrophotometer. The results thereof are that the electrically conductive yarn of sample 1 contained 29.1 parts by mass of Ag and 14.5 parts by mass of Al₂O₃ with respect to 100 parts by mass of the electrically conductive portion. In addition, the electrically conductive yarn of sample 2 contained 31.3 parts by mass of Ag and 15.6 parts by mass of Al₂O₃ with respect to 100 parts by mass of the electrically conductive portion.

### —Measurement of Electrical Resistance—

The electrical resistance of each electrically conductive yarn was calculated by applying a voltage of 1,000 V to ten samples of the electrically conductive yarn, each having a length of 10 cm, in a constant-temperature and constant-humidity environment at 20° C. and 30% RH and then computing the average value of the measured resistance values. The result thereof was that the electrical resistance of the electrically conductive yarn of sample 1 was 10 Ω/cm. The electrical resistance of the electrically conductive yarn of sample 2 was 3 Ω/cm. The electrical resistance of the electrically conductive yarn of sample 1C was 900 Ω/cm.

<Discussion>

The following is understood from the above results. In the electrically conductive yarn of sample 1C, the electrically conductive portion contains carbon nanotubes as a carbon-based material but does not contain metal. Consequently, the electrical resistance of the electrically conductive yarn of the sample 1C was an extremely large 900 Ω/cm. Accordingly, it can be said that it is difficult to use the electrically conductive yarn of sample 1C as a substitute for metal wire or the like.

In contrast, in the electrically conductive yarns of sample 1 and sample 2, the electrically conductive portion contains the carbon-based material, the binder, and the metal. Consequently, the electrical conductivity of the electrically conductive portion was greatly increased due to the synergistic effect between the carbon-based material and the metal. For that reason, according to the electrically conductive yarns of sample 1 and sample 2, it was confirmed that the electrical resistances could be greatly reduced compared to the electrically conductive yarn of sample 1C. Consequently, it can be said that if the electrically conductive yarns of sample 1 and sample 2 were used in, for example, the conductor of an electric wire, it is possible to obtain an electric wire that is lightweight, excels in flexing resistance, and has low electrical resistance.

In addition, in the electrically conductive yarns of sample 1 and sample 2, the electrically conductive portion has a network structure in which the carbon nanotubes are connected to one another, and the metal is interspersed within the network structure. According to this structure, it was also confirmed that a low electrical resistance of the electrically conductive portion could be obtained with certainty.

Although the above explained the details of the working examples of the present invention, the present invention is not limited to the above working examples and various modifications are possible within a range that does not depart from the gist of the present invention.

1. An electrically conductive yarn comprising:
a plurality of individual filaments; and
an electrically conductive portion that covers a surface of each of the individual filaments;
wherein the electrically conductive portion contains a carbon-based material—which includes carbon nanotubes—a binder, and a metal, and has a network structure in which the carbon nanotubes are connected to one another; and
the metal is interspersed within the network structure.

2. The electrically conductive yarn according to claim 1, wherein the electrically conductive portion further contains Al₂O₃.

3. The electrically conductive yarn according to claim 2, wherein the Al₂O₃ has a layer of the metal on its surface.

4. The electrically conductive yarn according to claim 3, wherein the metal is at least one selected from the group consisting of the Ag, Sn, Cu, Al, Zn, Fe, Ni, Co, Mg, Ti, Au, Pt group, and alloys thereof.

5. The electrically conductive yarn according to claim 3, wherein the metal is at least one of Ag and an Ag alloy.

6. The electrically conductive yarn according to claim 5, wherein the electrically conductive yarn has an electrical resistance of 30 Ω/cm or less.

7. The electrically conductive yarn according to claim 6, wherein the electrically conductive portion contains 30-100 parts by mass of the metal with respect to 100 parts by mass of the electrically conductive portion.

8. An electric wire comprising the electrically conductive yarn according to claim 1.

9. The electrically conductive yarn according to claim 1, wherein the metal is at least one selected from the group consisting of the Ag, Sn, Cu, Al, Zn, Fe, Ni, Co, Mg, Ti, Au, Pt group, and alloys thereof.

10. The electrically conductive yarn according to claim 1, wherein the metal is at least one of Ag and an Ag alloy.

11. The electrically conductive yarn according to claim 1, wherein the electrically conductive yarn has an electrical resistance of 30 Ω/cm or less.

12. The electrically conductive yarn according to claim 1, wherein the electrically conductive portion contains 30-100 parts by mass of the metal with respect to 100 parts by mass of the electrically conductive portion.

13. An electrically conductive yarn comprising:
a plurality of individual filaments; and
an electrically conductive material coating surfaces of the individual filaments and joining the individual filaments together;
wherein the electrically conductive material containing carbon nanotubes, a binder, and metal particles,
the electrically conductive material has a network structure in which the carbon nanotubes are connected to one another; and
the metal particles are interspersed within the network structure.

14. The electrically conductive yarn according to claim 13, wherein the electrically conductive material further contains Al₂O₃ particles.

15. The electrically conductive yarn according to claim 14, wherein the individual filaments are composed of one or more synthetic polymers selected from the group consisting of polyester-based resins, polyamide-based resins, polyolefin-based resins, acrylic-based resins and polyurethane-based resins.

16. The electrically conductive yarn according to claim 15, wherein the metal particles are composed of Ag or an Ag alloy.

17. The electrically conductive yarn according to claim 16, wherein:
the individual filaments are composed of a polyurethane-based resin; and
the binder is composed of a polyurethane-based resin.
